(19) United States
(12) Patent Application Publication
(10) Pub. No.: US 2021/0262477 A1
(43) Pub. Date: Aug. 26, 2021

(54) VACUUM PUMP AND SENSOR TARGET

(71) Applicant: Edwards Japan Limited, Chiba (JP)

(72) Inventor: Yongwei Shi, Chiba (JP)

(21) Appl. No.: 17/058,342

(22) PCT Filed: May 24, 2019
(86) PCT No.: PCT/JP2019/020771

§ 371 Date: Nov. 24, 2020

(30) Foreign Application Priority Data
Jun. 1, 2018 (JP) 2018-106095

(51) Int. Cl. F04D 27/00; F04D 19/04

(52) U.S. Cl. CPC F04D 27/001; F04D 19/04

(57) ABSTRACT

A vacuum pump and a sensor target are provided that are inexpensive and widen the linearity range of the sensor sensitivity as compared to a configuration in which a ferromagnetic material is used for the sensor target of a displacement sensor, and also reduce the possibility of touch down even when a disturbance occurs. An axial displacement sensor 109 includes a shaft 109A, which is extended through and fixed to the central section of a holder 5 holding an axial electromagnet 106, and a bobbin 109B, which is coupled to the upper end of the shaft 109A and around which a coil 7 is wound. A shaft end portion 113B, which has the shape of a small-diameter column, projects from the lower end of a rotor shaft 113 and is separated from the coil 7 by a gap 2. An external thread is formed on the outer circumference of the shaft end portion 113B so that a nut 19, which has an internal thread on the inner side, is engaged with the shaft end portion 113B. The area where the internal thread is formed does not extend over the entire thickness of the nut 19 and extends only partially. That is, the nut 19 has a threaded hole 19A opening only at the upper end. The nut 19 is made of a single material of low-carbon steel.

### BACKGROUND OF THE INVENTION

### 1. Field of the Invention

The present invention relates to a vacuum pump and a sensor target, and more particularly to a vacuum pump and a sensor target that are inexpensive and widen the linearity range of the sensor sensitivity as compared to a configuration in which a ferromagnetic material is used for the sensor target of a displacement sensor, and also reduce the possibility of touch down even when a disturbance occurs.

### 2. Description of the Related Art

The recent development of electronics has caused a surge in demand for semiconductors such as memories and integrated circuits.

These semiconductors are manufactured through steps such as doping extremely pure semiconductor substrates with impurities to give electrical properties, and etching fine circuits on the semiconductor substrates.

These steps need to be performed in a high-vacuum chamber to avoid the influence of dust or other substances in the air. A vacuum pump is typically used to exhaust the chamber, and a turbomolecular pump, which is a type of vacuum pump, is often used for reasons including less residual gas and easy maintenance.

The manufacturing process of semiconductors involves many steps that apply various process gases to semiconductor substrates. Turbomolecular pumps are used to exhaust such process gases from the chambers, as well as to produce a vacuum in the chambers.

FIG. 7 shows an example of a typical structure around an axial displacement sensor of a turbomolecular pump. As shown in FIG. 7, this turbomolecular pump has a rotor shaft 113, which rotates at a high speed, and a metal disc 111, which is coupled to the rotor shaft 113. The metal disc 111 is magnetically levitated in the axial direction by axial electromagnets (not shown), and the position of the metal disc 111 is controlled. To control the position, an axial displacement sensor 1 and a sensor target 3 are used to measure the size of the gap 2 between the lower end of the rotor shaft 113 and the axial displacement sensor 1. The axial displacement sensor 1 includes a shaft 1A, which is extended through and fixed to the central section of a holder 5 holding the axial electromagnets, and a bobbin 1B, which is coupled to the upper end of the shaft 1A and around which a coil 7 is wound. The sensor target 3 is arranged at the lower end of the rotor shaft 113 and separated from the coil 7 by a gap 2.

A shaft end portion 113A, which has the shape of a small-diameter column, projects from the lower end of the rotor shaft 113. An external thread is formed on the outer circumference of the shaft end portion 113A so that the metal disc 111 is fixed by a nut 9 at the lower end section of the rotor shaft 113. The nut 9 has an internal thread on the inner side. The nut 9 may be made of non-magnetic SUS 304 stainless steel, for example. The nut 9 has a columnar recess 11 at the center of the base thereof. The columnar sensor target 3 is embedded in the recess 11 and fixed with an adhesive.

The nut 9 does not have to have this specially formed columnar recess 11. A normal nut with an internal thread extending to the base may be used, and the sensor target 3 may adhere to the nut.

The coil 7 of the axial displacement sensor 1 fixed to the pump main body generates magnetic flux toward the sensor target 3, and the gap 2 between the lower end of the rotor shaft 113 and the axial displacement sensor 1 is measured in a non-contact manner. (See Japanese Patent Application Publication No. H11-313471 and Japanese Patent Application Publication No. 2000-283160, for example). For such measurement, the axial displacement sensor 1 needs to be small and yet have predetermined sensor sensitivity. For this reason, ferrite, which is a ferromagnetic material, is conventionally used for the sensor target 3.

However, ferrite is expensive even though it can serve as a small target with high magnetic permeability and improve the sensing accuracy of the displacement sensor. Additionally, the linearity is not maintained in a wide range with respect to the gap 2 between the lower end of the rotor shaft 113 and the axial displacement sensor 1.

In particular, the linearity of the sensor sensitivity is less likely to be obtained when the gap 2 is large, so that the gap 2 between the lower end of the rotor shaft 113 and the axial displacement sensor 1 cannot be sufficiently large. In this case, the small gap 2 can cause touch down when vibration is applied from outside due to an earthquake or other incidents, or when gas (atmosphere) is suddenly introduced into the chamber for some reason while the turbomolecular pump is exhausting gas from the chamber, releasing the pressure to atmospheric pressure from a vacuum state and causing the rotor blades to oscillate.

In view of such conventional problems, it is an objective of the present invention to provide a vacuum pump and a sensor target that are inexpensive and widen the linearity range of the sensor sensitivity as compared to a configuration in which a ferromagnetic material is used for the sensor target of a displacement sensor, and also reduce the possibility of touch down even when a disturbance occurs.

### SUMMARY OF THE INVENTION

The present invention (claim 1) may be an invention of a vacuum pump that includes: an axial displacement sensor including a sensor coil that is in a non-contact arrangement with a rotor shaft to detect axial displacement of the rotor shaft; and a sensor target that faces the axial displacement sensor and is separated from the axial displacement sensor by a gap. The sensor target is coupled to the rotor shaft to receive magnetic flux generated by the sensor coil. The sensor target includes magnetic metal.

The sensor target that includes magnetic metal widens the linearity range of the sensor sensitivity as compared to a configuration in which ferrite is used for the sensor target. The widened linearity range allows for a larger margin for the gap. The linearity is significantly different from that of a ferrite target sensor when the gap is large. Consequently, even when an external force is applied to the rotating body due to factors including inrush of atmosphere or vibration, the possibility of touch down is extremely low. The use of magnetic metal allows for a configuration that is less expensive than a configuration that uses ferrite.

The present invention (claim 2) may be an invention of a vacuum pump in which the metal is low-carbon steel having a carbon component of 0.13% to 0.28%.

This allows the displacement sensor to have a smaller coil, and allows the sensor target to be made of a material that is assessed to be reasonable in terms of workability, availability, and cost. As such, the linearity range is widened while maintaining the sensor sensitivity.

The present invention (claim 3) may be an invention of a vacuum pump in which the sensor target is a nut having an internal thread on an inner side.

When the sensor target is a nut, the strength of the rotor shaft is not reduced. The entire nut serves as one sensor target, simplifying the structure.

The present invention (claim 4) may be an invention of a sensor target for detecting axial displacement of a rotor shaft. The sensor target is configured to be positioned on the rotor shaft such that the sensor target faces an axial displacement sensor having a sensor coil and is separated from the axial displacement sensor by a gap. The sensor target includes magnetic metal for receiving magnetic flux generated by the sensor coil. The metal is low-carbon steel having a carbon component of 0.13% to 0.28%.

According to the present invention described above, the sensor target that is made of magnetic metal widens the linearity range while maintaining the sensor sensitivity as compared to a configuration in which ferrite is used for the sensor target. Consequently, even when an external force is applied to the rotating body due to factors including inrush of atmosphere or vibration, the possibility of touchdown is extremely low. The use of magnetic metal allows for a configuration that is less expensive than a configuration that uses ferrite.

### BRIEF DESCRIPTION OF THE DRAWINGS

FIG. 1 is a diagram showing the configuration of a turbomolecular pump;

FIG. 2 is a diagram showing the structure around an axial displacement sensor (an example in which the sensor target is a nut);

FIG. 3 is a diagram illustrating performance comparison among sensor targets each made of low-carbon steel or ferrite;

FIG. 4 is a diagram illustrating evaluated conceptual characteristics of the size of the detectable gap with respect to the voltage applied to the coil;

FIG. 5 is a diagram illustrating evaluated conceptual characteristics of the linearity of the detectable gap with respect to the voltage applied to the coil;

FIG. 6 is a diagram showing another mode of the present embodiment (an example in which the sensor target is a bolt); and

FIG. 7 is a diagram showing the structure around an axial displacement sensor (a conventional example).

### DESCRIPTION OF THE PREFERRED EMBODIMENTS

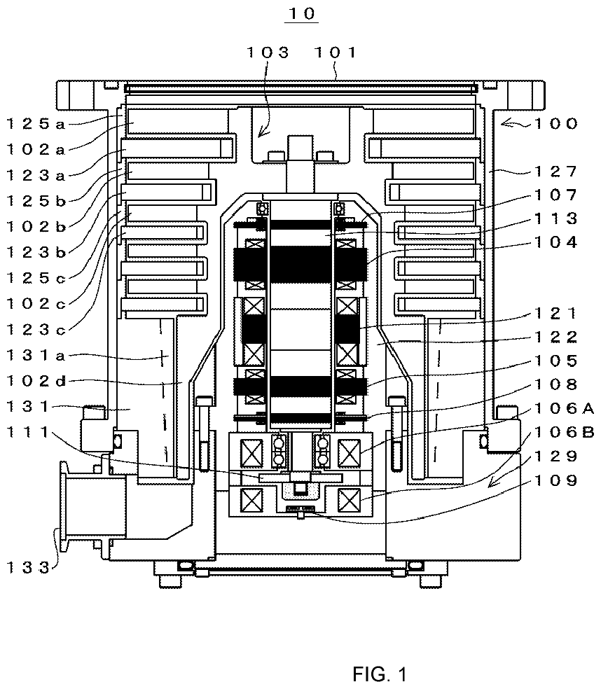

An embodiment of the present invention is now described. FIG. 1 is a diagram showing the configuration of a turbomolecular pump.

As shown in FIG. 1, a pump main body 100 has a circular outer cylinder 127 having an inlet port 101 at the upper end thereof. A rotating body 103 in the outer cylinder 127 includes a plurality of rotor blades 102a, 102b, 102c, . . . , which are turbine blades for gas suction and exhaustion, in the outer circumference section thereof. The rotor blades 102 extend radially in multiple stages.

The rotating body 103 has a rotor shaft 113 in the center, which is suspended in air and position-controlled by a 5-axis magnetic bearing, for example.

Four upper radial electromagnets 104 are arranged in pairs along an X-axis and a Y-axis, which are radial axes of the rotor shaft 113 that are perpendicular to each other. Four upper radial displacement sensors 107 including coils are positioned adjacent to and corresponding to the upper radial electromagnets 104. The upper radial displacement sensors 107 are configured to detect radial displacement of the rotor shaft 113 and send a signal on the displacement to a controller (not shown).

Based on the signal on the displacement detected by the upper radial displacement sensors 107, the controller controls the excitation of the upper radial electromagnets 104 via a compensation circuit with PID adjustment capability, and adjusts the radial position of the upper section of the rotor shaft 113.

The rotor shaft 113 may be made of a high magnetic permeability material (such as iron) and is attracted by the magnetic force of the upper radial electromagnets 104. The adjustment is performed independently in the X-axis direction and the Y-axis direction.

Lower radial electromagnets 105 and lower radial displacement sensors 108 are arranged in a similar manner as the upper radial electromagnets 104 and the upper radial displacement sensors 107 to adjust the radial position of the lower section of the rotor shaft 113 in a similar manner as the radial position of the upper section.

Axial electromagnets 106A and 106B are positioned to vertically sandwich a circular metal disc 111, which is provided in the lower section of the rotor shaft 113. The metal disc 111 is made of a high magnetic permeability material such as iron. An axial displacement sensor 109 is provided to detect axial displacement of the rotor shaft 113 and send a signal on the detected axial displacement to the controller.

Based on the axial displacement signal, the excitation of the axial electromagnets 106A and 106B is controlled through the compensation circuit of the controller with PID adjustment capability. The axial electromagnets 106A and 106B attract the metal disc 111 upward and downward, respectively, by magnetic force.

The controller appropriately adjusts the magnetic force exerted by the axial electromagnets 106A and 106B on the metal disc 111, magnetically levitates the rotor shaft 113 in the axial direction, and holds the rotor shaft 113 in space in a non-contact manner.

The motor 121 includes a plurality of magnetic poles circumferentially arranged so as to surround the rotor shaft 113. The controller controls these magnetic poles to drive and rotate the rotor shaft 113 by the electromagnetic force acting between the magnetic poles and the rotor shaft 113.

A plurality of stator blades 123a, 123b, 123c, . . . are arranged to be slightly separated from the rotor blades 102a, 102b, 102c, . . . . To transfer the exhaust gas molecules downward by collision, the rotor blades 102a, 102b, 102c, . . . are inclined by a predetermined angle from a plane perpendicular to the axis of the rotor shaft 113.

The stator blades 123 are also inclined by a predetermined angle from a plane perpendicular to the axis of the rotor shaft 113. The stator blades 123 extend inward of the outer cylinder 127 and alternate with the stages of the rotor blades 102.

One end of each stator blade 123 is inserted in and supported by a corresponding one of multiple stator blade spacers 125a, 125b, 125c, . . . formed in stages.

The stator blade spacers 125 are ring-shaped members made of a metal, such as aluminum, iron, stainless steel, or copper, or an alloy containing these metals as components, for example.

The outer cylinder 127 is fixed at the outer circumference of the stator blade spacers 125 and slightly separated from the stator blade spacers 125. The outer cylinder 127 has a base portion 129 at the base thereof. A threaded spacer 131 is provided between the lowest stator blade spacer 125 and the base portion 129. An outlet port 133 communicating with the outside is formed in a section of the base portion 129 below the threaded spacer 131.

The threaded spacer 131 is a cylindrical member made of a metal such as aluminum, copper, stainless steel, or iron, or an alloy containing these metals as components. The threaded spacer 131 has a plurality of helical thread grooves 131a in the inner circumference surface thereof.

When exhaust gas molecules move in the rotation direction of the rotating body 103, these molecules are transferred toward the outlet port 133 in the direction of the helix of the thread grooves 131a.

In the lowermost section of the rotating body 103 below the rotor blades 102a, 102b, 102c, . . . , a cylindrical portion 102d extends downward. The outer circumference surface of the cylindrical portion 102d is cylindrical and faces the inner circumference surface of the threaded spacer 131. This outer circumference surface is adjacent to but separated from the inner circumference surface of the threaded spacer 131 by a predetermined gap.

The base portion 129 is a disc-shaped member forming the base section of the turbomolecular pump 10, and is generally made of a metal such as iron, aluminum, or stainless steel.

The base portion 129 physically holds the turbomolecular pump 10 and also serves as a heat conduction path. As such, the base portion 129 is preferably made of rigid metal with high thermal conductivity, such as iron, aluminum, or copper.

In this configuration, when the motor 121 drives and rotates the rotor blades 102 together with the rotor shaft 113, the interaction between the rotor blades 102 and the stator blades 123 causes the suction of exhaust gas from the chamber through the inlet port 101.

The exhaust gas taken through the inlet port 101 moves between the rotor blades 102 and the stator blades 123 and is transferred to the base portion 129. At this time, factors such as the frictional heat generated when the exhaust gas comes into contact or collides with the rotor blades 102, and the conduction or radiation of the heat generated by the motor 121 increase the temperature of the rotor blades 102, and this heat is transmitted to the stator blades 123 by radiation or conduction through exhaust gas molecules, for example.

The stator blade spacers 125 are joined to each other at the outer circumference sections. The stator blade spacers 125 may transmit the heat received by the stator blades 123 from the rotor blades 102 and the frictional heat generated when the exhaust gas comes into contact or collides with the stator blades 123 to the outer cylinder 127 and the threaded spacer 131.

The exhaust gas transferred to the threaded spacer 131 is guided by the thread grooves 131a to the outlet port 133.

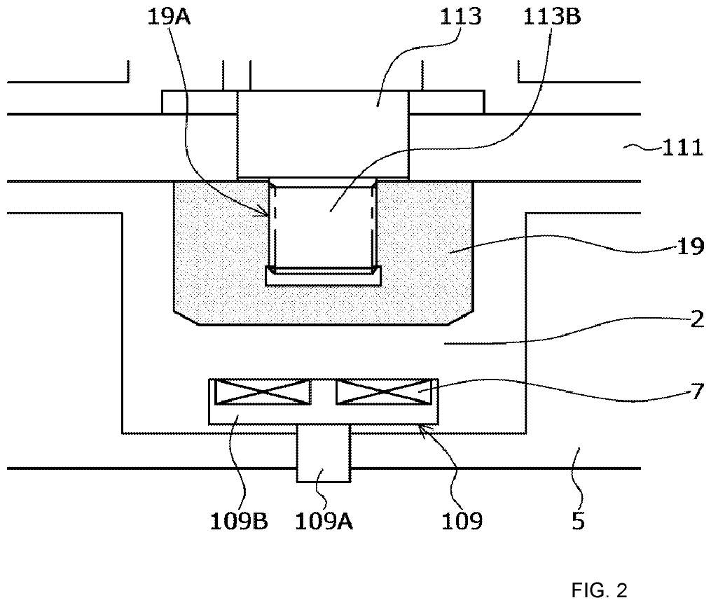

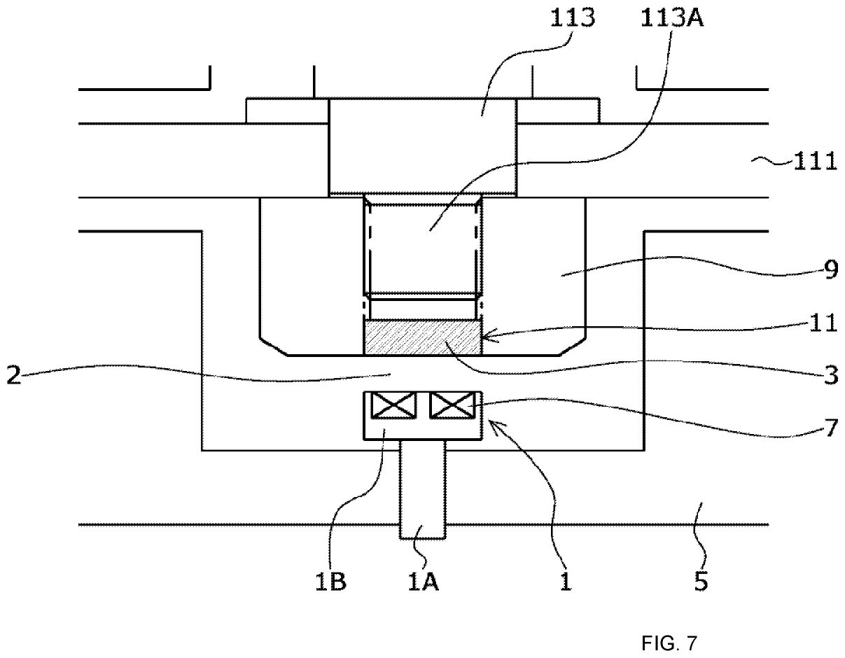

Referring to FIG. 2, the structure around the axial displacement sensor is now described. FIG. 2 is a diagram illustrating the structure around the axial displacement sensor 109 enlarged for easier comparison with FIG. 7. The axial displacement sensor 109 includes a shaft 109A, which is extended through and fixed to the central section of a holder 5 holding the axial electromagnets 106, and a bobbin 109B, which is coupled to the upper end of the shaft 109A and around which a coil 7 is wound.

A shaft end portion 113B, which has the shape of a small-diameter column, projects from the lower end of the rotor shaft 113 and is separated from the coil 7 by a gap 2. An external thread is formed on the outer circumference of the shaft end portion 113B so that a nut 19, which has an internal thread on the inner side, is engaged with the shaft end portion 113B. The area where the internal thread is formed does not extend over the entire thickness of the nut 19 and extends only partially. That is, the nut 19 has a threaded hole 19A opening only at the upper end. The nut 19 is made of a single material of low-carbon steel.

The drill hole for the internal thread has a flat bottom surface as shown in FIG. 2 to reduce the axial dimension of the nut and to limit stress concentration during the rotation of the rotor shaft and the rotating body.

However, the drill hole may be a normal drill hole when the limitation on the axial dimension is not severe, and when some degree of stress concentration will not hinder the rotation of the rotor shaft and the rotating body.

The operation of the present embodiment is now described.

The whole nut 19 is made of a single metal material and functions as the sensor target of the axial displacement sensor 109. The nut 19 engages with the shaft end portion 113B of the rotor shaft 113, thereby providing strength around the shaft end portion 113B. When the magnetic flux generated by the coil 7 reaches the sensor target, the distance of the gap 2 is measured based on the change in the inductance.

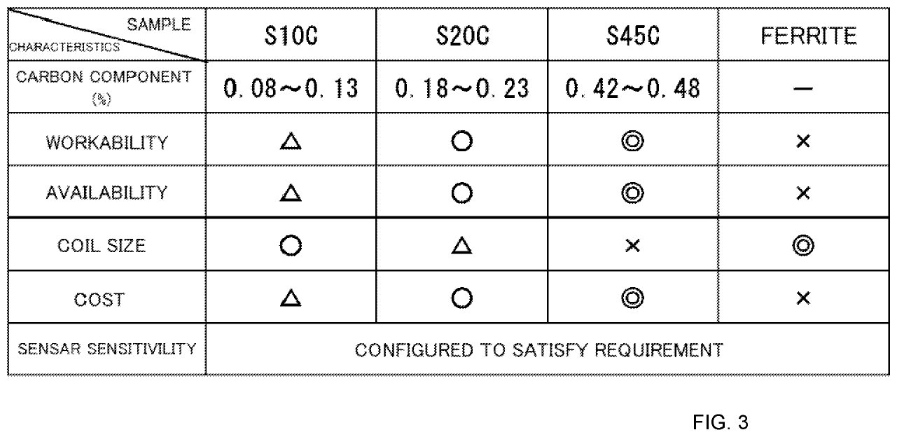

FIG. 3 summarizes the comparison of performances of sensor targets for the axial displacement sensor 109 that are each made of low-carbon steel or ferrite. Here, S10C, S20C, and S45C specified by the Japanese Industrial Standards are used as examples of magnetic low-carbon steel. The table also indicates the carbon component (carbon content) of the low-carbon steel. The performances are relatively evaluated among the four types of materials and rated on a four-level scale of ◯◯, ◯, Δ, X, in the order of ◯◯ (Excellent), ◯ (Good), Δ (Satisfactory), and X (poor). As can be seen from FIG. 3, ferrite achieves the smallest coil among the four types of evaluated materials since it has high magnetic permeability and tends to create a concentrated magnetic flux. However, the cost therefor is the highest among the four types of evaluated materials, and the workability and availability are inferior to those of the other three types of evaluated materials.

In terms of workability, availability, and cost, S45C, which has a larger carbon component, is the highest among the four types of evaluated materials, but the low magnetic permeability thereof inevitably results in a large coil. It can be seen that S20C is assessed to be reasonable in terms of workability, availability, and cost while limiting the size of the coil. Instead of low-carbon steel, it is also possible to use magnetic stainless steel (such as the SUS400 series and SUS420 in particular), which is also a magnetic material. However, stainless steel has poor workability as compared to low-carbon steel such as S20C.

The sensor sensitivity is now described.

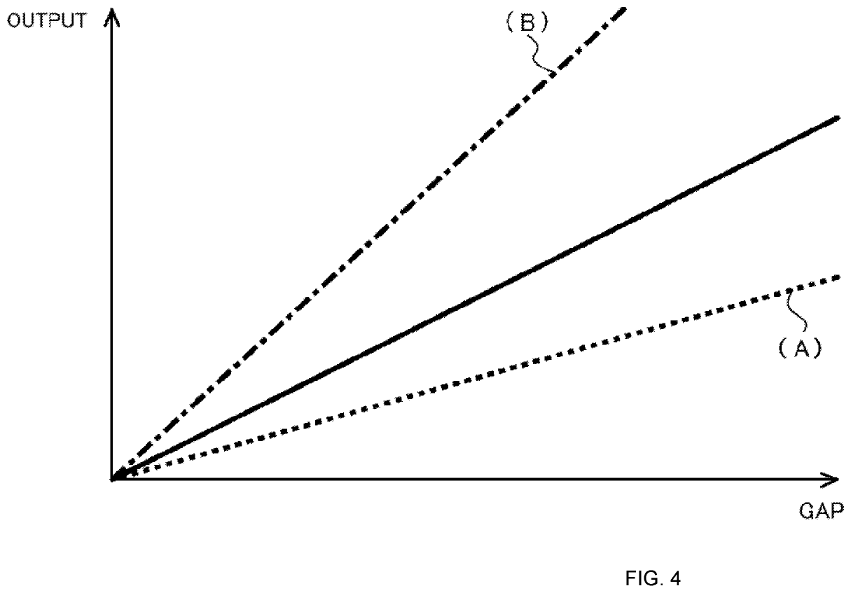

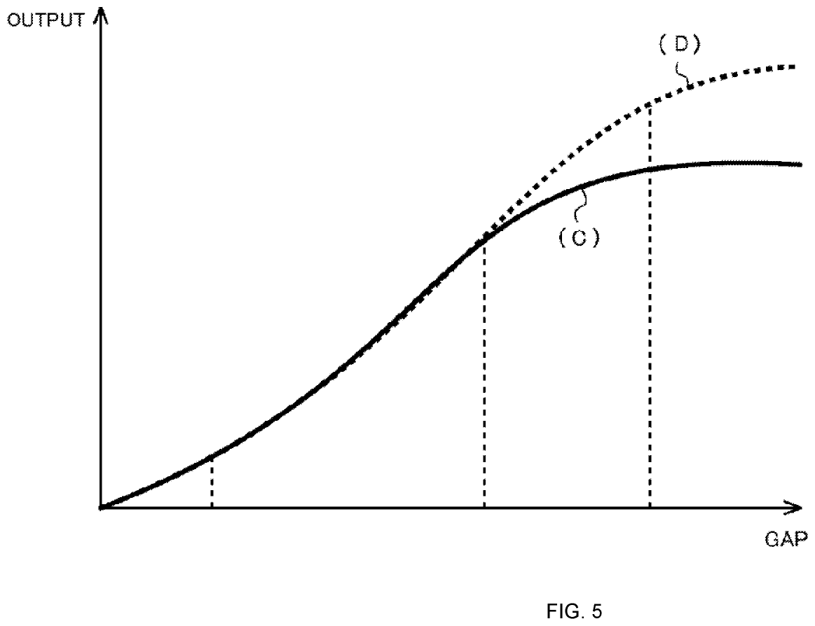

FIG. 4 illustrates the evaluated conceptual characteristics of the size of the detectable gap 2 with respect to the voltage applied to the coil. FIG. 5 illustrates the evaluated conceptual characteristics of the linearity of the detectable gap 2 with respect to the voltage applied to the coil. Of the sensitivity characteristic lines in FIG. 4, the inclined characteristic line indicated by the letter “A” corresponds to ferrite and has the highest sensitivity, and the inclined characteristic line indicated by the letter “B” corresponds to S45C and has inferior sensitivity. That is, the inclinations of the lines have the same tendency as the evaluated sizes of the coils shown in FIG. 3, and the inclination angle gradually increases and thus the sensitivity decreases in the order of S10C, S20C, and S45C.

To solve this problem, the present embodiment increases the number of turns of the coil using the empty space on the radially outer side of the bobbin 109B so as to create a larger magnetic flux, thereby achieving the sensitivity equivalent to that of ferrite. For example, when S20C is used, the number of turns is about 50% greater than that for ferrite.

As can be seen from the linearity characteristics of FIG. 5, ferrite, which is indicated by the letter “C”, cannot maintain the linearity in the region where the gap 2 is large. In contrast, S20C, which is indicated by the letter “D”, can maintain the linearity in the region where the gap 2 is large, as compared to ferrite.

The evaluation results described above demonstrate that when the sensor target of the axial displacement sensor 109 is formed of a single magnetic material in the shape of a nut and the nut is made of low-carbon steel, such as S20C, the linearity range can be widened while maintaining the sensor sensitivity as compared to a configuration in which ferrite is used for the sensor target. The widened linearity range allows for a larger margin for the gap 2. The linearity differs significantly especially when the gap 2 is large. Consequently, even when an external force is applied to the rotating body 103 due to factors including inrush of atmosphere or vibration, the possibility of touch down is extremely low.

Ferrite is conventionally used only for the core section, but this still increases the cost. The present embodiment uses inexpensive magnetic low-carbon steel as a single material forming the nut that serves as the sensor target and a fixing portion. S20C is used as an example of low-carbon steel for the purpose of illustration, but S15C (with a carbon component of 0.13% to 0.18%) to S25C (with a carbon component of 0.22% to 0.28%) may be suitably used as low-carbon steel. That is, a magnetic material having a carbon component of 0.13% to 0.28% is desirable.

The low-carbon steel described above is suggested based on the comprehensive evaluation. However, the material may be selected based on each of the workability, availability, coil size, cost, and the required sensor sensitivity. For example, S45C (with a carbon content of 0.42% to 0.48%) may be used in consideration of the workability, availability, and cost, while S10C (with a carbon content of 0.08% to 0.13%) may be used in consideration of the coil size. Furthermore, stainless steel (such as the SUS400 series and SUS420 in particular) may also be used.

The present embodiment may be modified as follows.

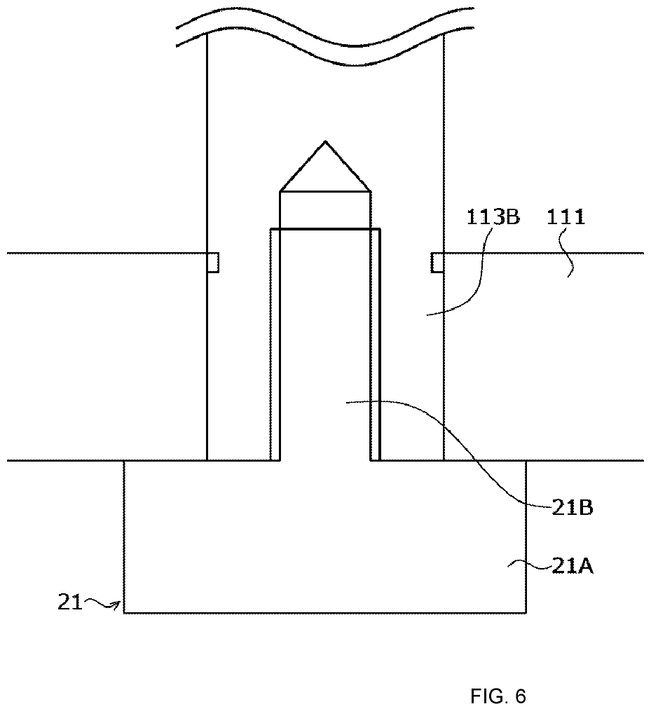

In the present embodiment, the nut 19 is engaged with the shaft end portion 113B. In a modification of the present embodiment, a bolt 21 may be used in place of the nut 19 as shown in FIG. 6. In this case, the bolt 21 includes a bolt head 21A and a thread portion 21B made of a single magnetic material, which may be magnetic low-carbon steel having a carbon component of 0.13% to 0.28%.

Since the bolt head 21A is made of low-carbon steel, the linearity range is widened as compared to a configuration in which ferrite is used for the sensor target, while maintaining the sensor sensitivity, in the same manner as the nut 19 of the present embodiment.

The invention is amenable to various modifications without departing from the spirit of the invention. The invention is intended to cover all modifications.

### REFERENCE SIGNS LIST

2 Gap
5 Holder
7 Coil
19 Nut
19a Threaded hole
21 Bolt
21a Bolt head
103 Rotating body
109 Axial displacement sensor
109a Shaft
109b Bobbin
111 Metal disc
113 Rotor shaft
113b Shaft end portion

What is claimed is:

1. A vacuum pump comprising:
an axial displacement sensor including a sensor coil that is in a non-contact arrangement with a rotor shaft so as to detect axial displacement of the rotor shaft; and
a sensor target that faces the axial displacement sensor and is separated from the axial displacement sensor by a gap, the sensor target being coupled to the rotor shaft configured to receive magnetic flux generated by the sensor coil, wherein
the sensor target comprises a magnetic metal.

2. The vacuum pump according to claim 1, wherein the metal is low-carbon steel having a carbon component of 0.13% to 0.28%.

3. The vacuum pump according to claim 1 or 2, wherein the sensor target is a nut having an internal thread on an inner side.

4. A sensor target for detecting axial displacement of a rotor shaft, wherein
the sensor target is configured to be positioned on the rotor shaft such that the sensor target faces an axial displacement sensor having a sensor coil and is separated from the axial displacement sensor by a gap and the sensor target comprises magnetic metal for receiving magnetic flux generated by the sensor coil, and
the metal is low-carbon steel having a carbon component of 0.13% to 0.28%.
